(19) United States
(12) Patent Application Publication
(10) Pub. No.: US 2011/0292022 A1
(43) Pub. Date: Dec. 1, 2011

(54) POWER CONVERTING APPARATUS AND POWER CONVERTING METHOD

(75) Inventors: Tzung-Yuan Lee, Taichung County (TW); Shang-I Liu, Kaohsiung City (TW); Chun-Yi Chou, Hsinchu City (TW); Wing-Kai Tang, Hsinchu City (TW)

(73) Assignee: NOVATEK MICROELECTRONICS CORP., Hsinchu (TW)

(21) Appl. No.: 12/826,715

(22) Filed: Jun. 30, 2010

(30) Foreign Application Priority Data
May 27, 2010 (TW) 99117026

(51) Int. Cl. G06F 3/038

(52) U.S. Cl. 345/212; 345/87

(57) ABSTRACT

A power converting apparatus including a power converting unit and a control unit is provided. The power converting unit receives an input voltage and generates an output voltage for a display driving unit according to a control signal. The control unit provides the control signal to the power converting unit, wherein the control unit adjusts the duty cycle or the frequency of the control signal according to an image signal. In addition, a power converting method is also provided.

### CROSS-REFERENCE TO RELATED APPLICATION

This application claims the priority benefit of Taiwan application serial no. 99117026, filed on May 27, 2010. The entirety of the above-mentioned patent application is hereby incorporated by reference herein and made a part of specification.

### BACKGROUND OF THE INVENTION

1. Field of the Invention

The invention generally relates to a power converting apparatus and a method thereof, and more particularly, to a power converting apparatus with adaptive control and a method thereof.

2. Description of Related Art

An existing display driving circuit usually includes a voltage boosting circuit. Taking a display driving chip in a liquid crystal display (LCD) as an example, a higher voltage is required for driving the common end of pixels on the display panel and accordingly a voltage boosting circuit is necessary. Presently, two types of voltage boosting circuits are usually adopted in display driving chips, one is capacitive charge pump and the other is inductive voltage boosting circuit (booster). These two types of voltage boosting circuits respectively have their own pros and cons but are both designed for pulling up a voltage.

Regarding a normally black LCD, the display driving chip thereof consumes less power when a black frame is displayed, and the display driving chip thereof consumes more power when a white frame is displayed. Contrarily, regarding a normally white LCD, the display driving chip thereof consumes less power when a white frame is displayed, and the display driving chip thereof consumes more power when a black frame is displayed.

However, the duty cycle or the frequency of a control signal in an existing display driving circuit (regardless of whether a capacitive or inductive voltage boosting circuit is adopted) is not adjusted along with different display content. In other words, the power supplied by the voltage boosting circuit always remains the same and is not adjustable along with different display content. As a result, the LCD is not efficient in either its power consumption or it performance.

### SUMMARY OF THE INVENTION

Accordingly, the invention is directed to a power converting apparatus adapted to a display driving apparatus, wherein the power converting apparatus adjusts an electrical characteristic (for example, a signal amplitude, a voltage level, or a current intensity) of a control signal thereof according to different display content of the display driving apparatus.

The invention is directed to a power converting method adaptable to a power converting apparatus of a display driving apparatus, wherein an electrical characteristic (for example, a signal amplitude, a voltage level, or a current intensity) of a control signal of the power converting apparatus is adjusted according to different display content of the display driving apparatus.

The invention provides a power converting apparatus including a power converting unit and a control unit. The power converting unit receives an input voltage and generates an output voltage for a load according to a control signal. The control unit provides the control signal to the power converting unit, wherein the control unit adjusts an electrical characteristic of the control signal according to an image signal.

According to an embodiment of the invention, the control unit analyzes an image content characteristic of the image signal and adjusts the duty cycle or the frequency of the control signal according to an analysis result.

According to an embodiment of the invention, the control unit analyzes an image content characteristic of an N^{th} image frame of the image signal and adjusts the duty cycle or the frequency of the control signal according to the analysis result, wherein N is a positive integer.

According to an embodiment of the invention, the control unit analyzes image content characteristics of an N^{th} image frame to a (N+K)^{th} image frame of the image signal and adjusts the duty cycle or the frequency of the control signal according to the analysis result, wherein N and k are respectively a positive integer.

According to an embodiment of the invention, the control unit analyzes image content characteristics of an N^{th} image frame and a M^{th} image frame of the image signal and adjusts the duty cycle or the frequency of the control signal according to the analysis result, wherein N and M are respectively a positive integer, and M>N.

The invention provides a power converting method including following steps. An electrical characteristic of a control signal is adjusted according to an image signal. An input voltage is converted into an output voltage according to the control signal. The output voltage is supplied to a load.

According to an embodiment of the invention, the step of adjusting the electrical characteristic of the control signal includes following steps. An image content characteristic of the image signal is analyzed. The duty cycle or the frequency of the control signal is adjusted according to an analysis result.

According to an embodiment of the invention, while analyzing the image content characteristic of the image signal, an image content characteristic of an N^{th} image frame of the image signal is analyzed, and the duty cycle or the frequency of the control signal is adjusted according to the analysis result, wherein N is a positive integer.

According to an embodiment of the invention, while analyzing the image content characteristic of the image signal, image content characteristics of an N^{th} image frame to a (N+k)^{th} image frame of the image signal are analyzed, and the duty cycle or the frequency of the control signal is adjusted according to the analysis result, wherein N and k are respectively a positive integer.

According to an embodiment of the invention, while analyzing the image content characteristic of the image signal, image content characteristics of an N^{th} image frame and a M^{th} image frame of the image signal are analyzed, and the duty cycle or the frequency of the control signal is adjusted according to the analysis result, wherein N and M are respectively a positive integer, and M>N.

As described above, in an embodiment of the invention, a control unit of a power converting apparatus adjusts the duty cycle, frequency, or other electrical characteristics (for example, a signal amplitude, a voltage level, or a current intensity) of a control signal according to an image signal, so that a power converting unit can provide different power along with different display content of a display. Thereby, the power consumption of the display is reduced and the efficiency thereof is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a display according to an embodiment of the invention.

FIG. 2A and FIG. 2B are circuit diagrams of a power converting unit during different time periods according to an embodiment of the invention.

FIG. 3 is a diagram illustrating the waveform of a control signal.

FIG. 4 is a circuit diagram of a power converting apparatus according to an embodiment of the invention.

FIG. 5 is a flowchart of a power converting method according to an embodiment of the invention.

FIG. 6 is a histogram illustrating the pixel brightness distribution on a display panel in FIG. 1.

FIG. 7 is a flowchart of a power converting method according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In following embodiments, a liquid crystal display (LCD) and a voltage boosting circuit thereof will be taken as examples. However, it should be understood by those having ordinary knowledge in the art that the LCD and the voltage boosting circuit thereof are not intended to limit the scope of the display and the power converting circuit thereof in the invention. Meanwhile, the invention is not limited to applications of capacitive or inductive power converting circuit, and any electronic circuit with a power converting function is within the scope of the invention.

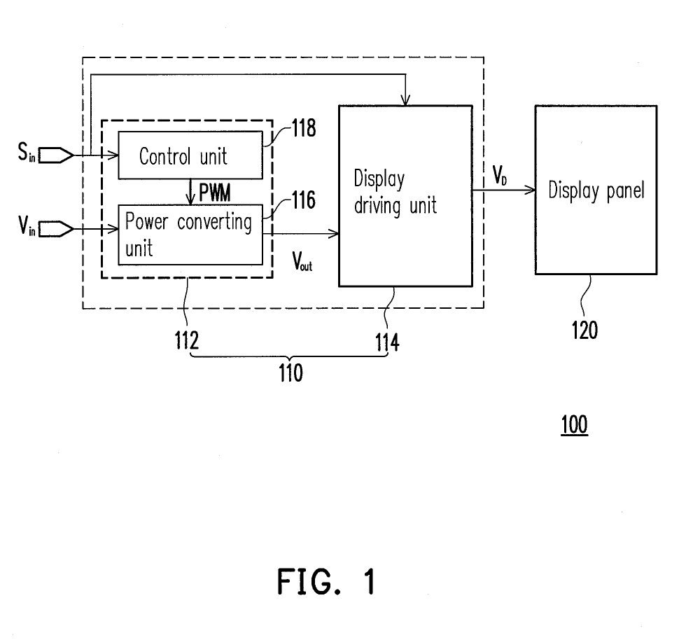

FIG. 1 is a block diagram of a display according to an embodiment of the invention. Referring to FIG. 1, in the present embodiment, the display 100 includes a display driving apparatus 110 and a display panel 120. The display driving apparatus 110 includes a power converting apparatus 112 and a display driving unit 114, wherein the display driving unit 114 drives the display panel 120.

In the present embodiment, the power converting apparatus 112 includes a power converting unit 116 and a control unit 118. The power converting unit 116 receives an input voltage Vᵢₙ and generates an output voltage Vₒᵤₜ for the display driving unit 114 according to a control signal PWM. The control unit 118 provides the control signal PWM to the power converting unit 116, wherein the control unit 118 adjusts an electrical characteristic of the control signal PWM according to an image signal Sᵢₙ.

In following exemplary embodiments, it is assumed that the control unit 118 adjusts the duty cycle or the frequency of the control signal PWM. However, the invention is not limited thereto. When the control unit 118 adjusts the duty cycle or the frequency of the control signal PWM according to the image signal Sᵢₙ, the power converting unit 116 can provide different power along with different display content of a display, so that the power consumption of the display is reduced and the efficiency thereof is improved. In other embodiments, the control unit 118 may also adjust other electrical characteristics of the control signal PWM so that the power converting unit 116 can provide different power along with different display content of the display.

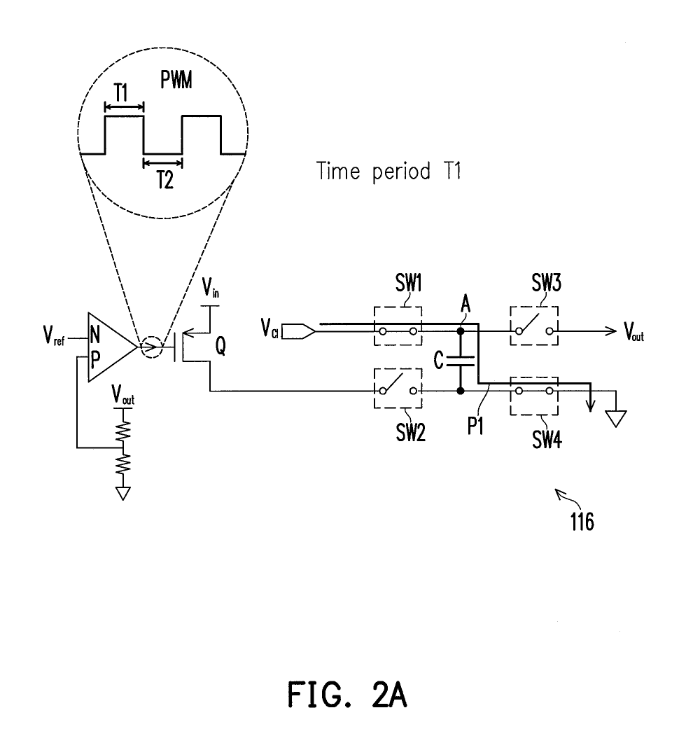

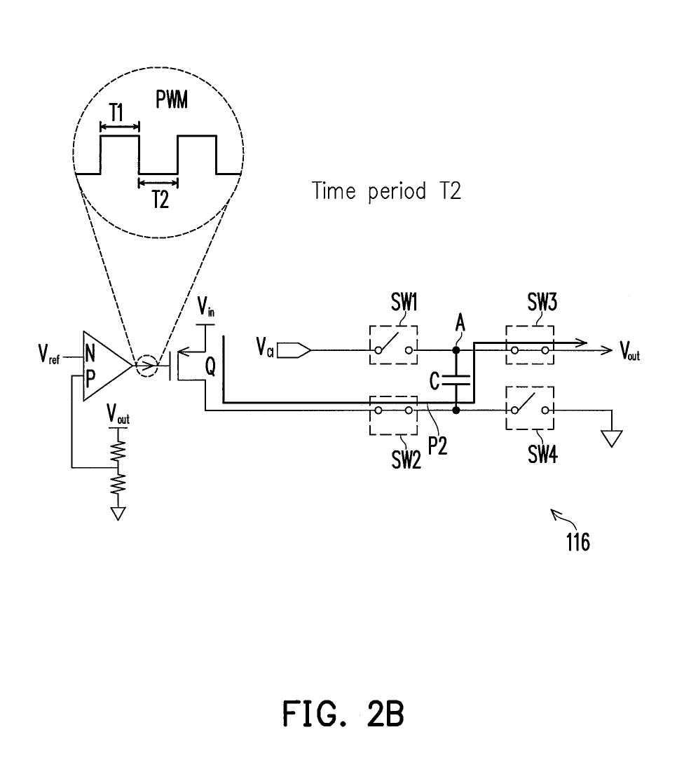

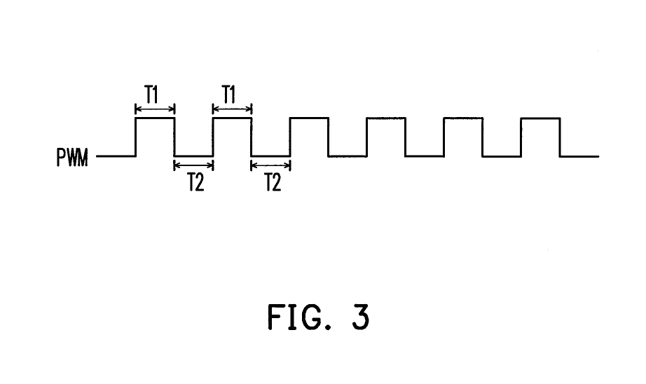

Specifically, FIG. 2A and FIG. 2B are circuit diagrams of the power converting unit 116 during different time periods T1 and T2 according to an embodiment of the invention. FIG. 3 is a diagram illustrating the waveform of the control signal PWM.

Referring to FIG. 2A, FIG. 2B, and FIG. 3, in the present embodiment, the control signal PWM is a pulse width modulation (PWM) signal, and the duty cycle thereof is T1/(T1+T2) (i.e., the ratio of the time period T1 (during which the control signal PWM is at a high voltage level) to the pulse period T1+T2).

Herein, The power converting unit 116 illustrated in FIG. 2A and FIG. 2B is described as a capacitive voltage boosting circuit. However, the invention is not limited thereto. In other embodiments, the power converting unit may also be an inductive voltage boosting circuit, a composite capacitive-inductive voltage boosting circuit, or other types of voltage boosting circuit.

In the present embodiment, during the time period T1, the switches SW1 and SW4 are turned on and the switches SW2 and SW3 are turned off through a digital control technique. In this case, the transistor Q is turned off and the voltage V_{CI} charges the capacitor C via the charging path P1. Thus, the voltage at the end A of the capacitor C is V_{CI}.

Then, during the time period T2, the switches SW2 and SW3 are turned on and the switches SW1 and SW4 are turned off through the digital control technique. In this case, the transistor Q is turned on and the input voltage Vᵢₙ charges the capacitor C via the charging path P2. Thus, the voltage at the end A of the capacitor C is V_{CI}+Vᵢₙ.

Accordingly, after at least one pulse period T1+T2, the voltage at the end A is pulled up to V_{CI}+Vᵢₙ and provided to the display driving unit 114 as the output voltage Vₒᵤₜ.

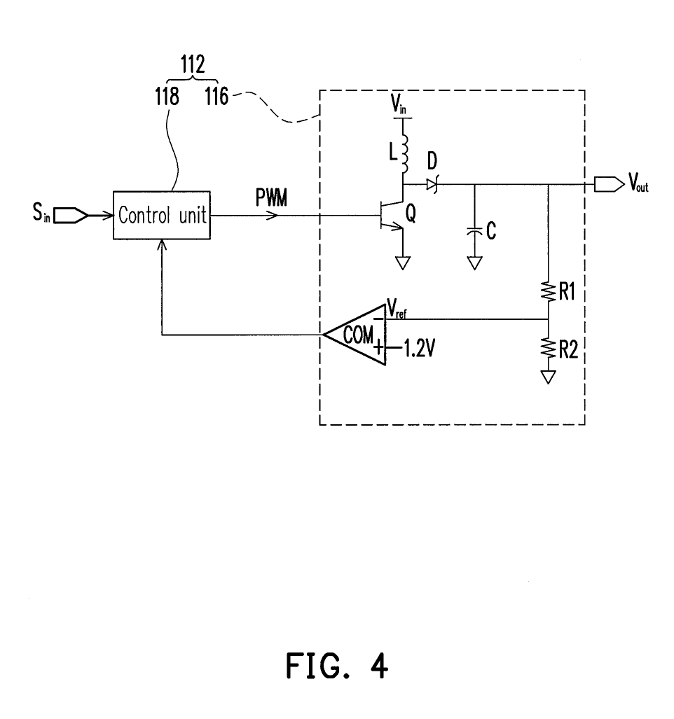

FIG. 4 is a circuit diagram of a power converting apparatus according to an embodiment of the invention. Referring to FIG. 4, the power converting apparatus 112 in the present embodiment is described as an inductive voltage boosting circuit. However, the invention is not limited thereto.

In the present embodiment, the control unit 118 turns on or off the transistor Q through the control signal PWM so as to charge the capacitor C with the input voltage Vᵢₙ. Thus, after at least one pulse period T1+T2, the output voltage Vₒᵤₜ is pulled up and provided to the display driving unit 114. Meanwhile, a voltage feedback is accomplished through the voltage division resistors R1 and R2 and a comparator COM so that the output voltage Vₒᵤₜ is kept within a specific range.

According to the exemplary embodiments illustrated in FIGS. 2A-4, the duty cycle or the frequency of the control signal PWM affects the power consumption and the efficiency of the power converting unit 116 and the ripple size of the output voltage Vₒᵤₜ.

Thus, in an embodiment of the invention, the control unit 118 adjusts the duty cycle or the frequency of the control signal PWM according to an image signal Sᵢₙ so as to allow the power converting unit 116 to provide different voltage along with different display content, so that the power consumption can be reduced and the efficiency can be improved.

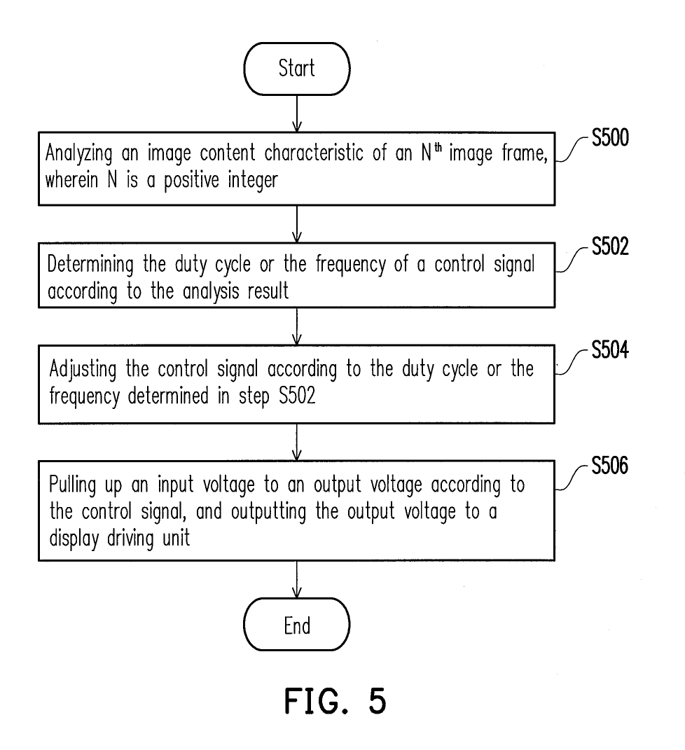

FIG. 5 is a flowchart of a power converting method according to an embodiment of the invention. Referring to FIG. 1 and FIG. 5, in the present embodiment, the control unit 118 first analyzes an image content characteristic of an N^{th} image frame of the image signal Sᵢₙ, as in step S500.

The N^{th} image frame may be the currently displayed image frame. In other embodiments, the N^{th} image frame may also be an image frame of the image signal Sᵢₙ that has been displayed before or is to be displayed in the future.

In the present embodiment, the image content characteristic analyzed by the control unit 118 may be the image resolution, the image brightness, the image spectral distribution, the image discrepancy, the image relevancy, the image color depth, the image refresh rate, or the display mode of the image frame.

Next, in step S502, the control unit 118 determines the duty cycle or the frequency of the control signal PWM according to the analysis result. Herein, the control unit 118 determines the duty cycle or the frequency of the control signal PWM through calculation, table lookup, experience rule, expert system, or other techniques.

In step S504, the control unit 118 adjusts the control signal PWM according to the duty cycle or the frequency determined in step S502 through a digital or an analog technique.

Finally, in step S506, the power converting unit 116 pulls up the input voltage Vᵢₙ to generate the output voltage Vₒᵤₜ according to the control signal PWM provided by the control unit 118 and outputs the output voltage Vₒᵤₜ to the display driving unit 114.

In another embodiment, the control unit 118 analyzes the image content characteristics of an N^{th} image frame and a M^{th} image frame of the image signal Sᵢₙ. Herein the N^{th} image frame may be the currently displayed image frame, and the M^{th} image frame may be an image frame to be displayed in the future, wherein N and M are respectively a positive integer, and M>N.

Thus, the control unit 118 analyzes the image content characteristics (for example, image resolution, image brightness, image spectral distribution, image resolution, image discrepancy, image relevancy, image color depth, image refresh rate, or display mode) of the N^{th} image frame and the M^{th} image frame and compares the difference between the two to determine the duty cycle or the frequency of the control signal PWM.

Below, how to analyze different image content characteristics will be described with reference to exemplary embodiments of the invention.

Regarding the resolution of image frame, the same display driving apparatus may be used to display image frames having different resolutions. For example, more pixels are driven by the display driving apparatus when the image frame has a higher resolution, and less pixels are driven by the display driving apparatus when the image frame has a lower resolution.

Thus, after the control unit analyzes the resolution of an image frame, if the analysis result indicates that the resolution is lower than a specific threshold, the control unit adjusts the duty cycle or the frequency of the control signal to a predetermined duty cycle or frequency according to the analysis result. Contrarily, if the analysis result indicates that the resolution is higher than the specific threshold, the control unit adjusts the duty cycle or the frequency of the control signal to another predetermined duty cycle or frequency according to the analysis result.

In other words, the control unit adaptively adjusts the duty cycle or the frequency of the control signal according to different image frame resolutions. The adjustment may be done through table lookup, linear scaling, experience rule, non-linear rule, theoretical calculation, or customized special mode. However, the invention is not limited thereto.

Regarding the brightness of image frame, taking a display driving apparatus of an organic light emitting diode (OLED) display as an example, when a darker frame is displayed by the OLED display, a smaller driving current is required by the display panel. Accordingly, the smallest driving current is required by the display panel when the image frame is totally black, and the largest driving current is required by the display panel when the image frame is totally white.

In other words, regardless of an OLED display, a LCD, a plasma display, a cathode-ray tube (CRT) display, or any other display, the display driving apparatus thereof provides different voltages or currents with respect to image frames of different brightness.

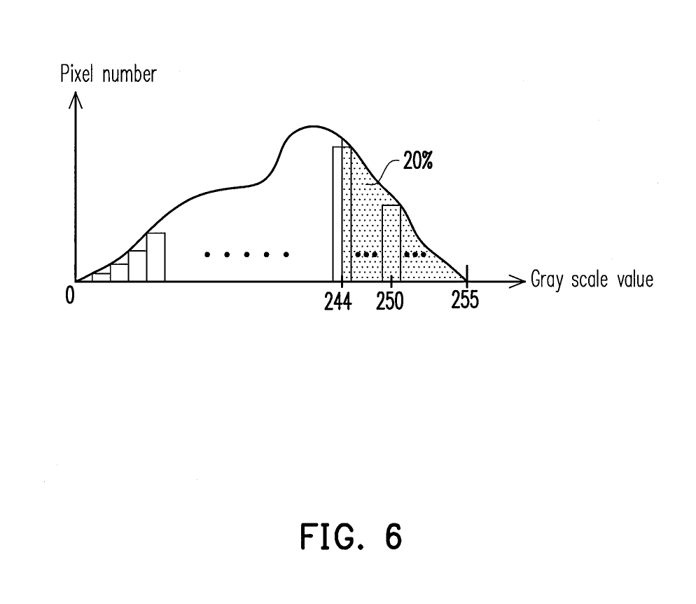

FIG. 6 is a brightness distribution histogram of pixels on the display panel 120 in FIG. 1. Referring to FIG. 1 and FIG. 6, the brightness distribution histogram illustrated in FIG. 6 is corresponding to an image frame having a resolution of 480*800 and an 8-bit color depth (i.e., 0 represents the darkest color and 255 represents the brightest color). Thus, more pixels are distributed around the higher grayscale values if a brighter image frame is displayed on the display panel 120.

Herein a statistical parameter 20% is taken as a reference threshold when a counted pixel number is 20% of the total pixel number. Taking an image frame having a resolution of 480*800 as an example, if the total pixel number is 480*800=384,000, then 20% of the total pixel number is 384,000*20%=76,800.

To be specific, assuming that the value N₂₅₅ represents the total pixel number corresponding to the grayscale value 255 in the image, the value N₂₅₄ represents the total pixel number corresponding to the grayscale value 254 in the image, the value N₂₅₃ represents the total pixel number corresponding to the grayscale value 253 in the image, . . . , the value N₁ represents the total pixel number corresponding to the grayscale value 1 in the image, and the value N₀ represents the total pixel number corresponding to the grayscale value 0 in the image. Thus, when the value N₂₅₅>=76,800, 20% of the pixels in the image are distributed at the grayscale value 255. Herein since the value N₂₅₅ is already greater than 20% of the total pixel number (i.e., the counted pixel number has reached the predetermined percentage of 20%), the control unit uses the grayscale value 255 as an index and adjusts the duty cycle or the frequency of the control signal according to this index.

In the brightness distribution histogram illustrated in FIG. 6, the grayscale value 244 is used as the index. In other words, 20% of the pixels are distributed between the grayscale values 244 and 255 when N₂₅₅+N₂₅₄+N₂₅₃+ . . . +N₂₄₄>=76,800.

Assuming that N₂₅₅+N₂₅₄+N₂₅₃+ . . . +N₂₄₀>=76,800 (i.e., 20% of the pixels are distributed between the grayscale values 240 and 255), the control unit uses the grayscale value 240 as an index and adjusts the duty cycle or the frequency of the control signal according to this index.

Assuming that N₂₅₅+N₂₅₄+N₂₅₃+ . . . +N₁₃>=76,800 (i.e., 20% of the pixels are distributed between the grayscale values 13 and 255), the control unit uses the grayscale value 13 as the index and adjusts the duty cycle or the frequency of the control signal according to this index.

Based on foregoing rules, a brighter image has a higher brightness index since the pixels thereof are mostly distributed around higher grayscale values. Contrarily, a darker image has a lower brightness index since the pixels thereof are mostly distributed around lower grayscale values.

Whether a currently displayed image is bright or dark can be determined according to an index generated based on foregoing rules. Accordingly, the duty cycle, frequency, or another electrical characteristic (for example, a signal amplitude, a voltage level, or a current intensity) of a control circuit in a voltage boosting circuit can be determined according to the brightness index.

Herein the duty cycle or the frequency of the control signal may be adjusted through table lookup, linear scaling, experience rule, non-linear rule, theoretical calculation, or customized special mode. However, the invention is not limited thereto. In addition, foregoing calculation method is not intended to limiting the invention either.

Accordingly, the control unit can adaptively adjust the duty cycle or the frequency of the control signal according to different image frame brightness. The adjustment may be done through table lookup, linear scaling, experience rule, non-linear rule, theoretical calculation, or customized special mode. However, the invention is not limited thereto. In addition, how to obtain the image brightness, the image brightness variation, or the frequency of image brightness variation is not limited in the invention.

Regarding the spectral distribution of image frame, two consecutive image frames have different spectral distributions when the two image frames have different grains. Thus, when the spectral distributions of two consecutive image frames change greatly or frequently, the display content of the display panel changes to different extent, and different display content results in different power consumption performance.

Accordingly, the control unit can adaptively adjust the duty cycle or the frequency of the control signal according to the spectral distribution of different image frame. The adjustment may be done through table lookup, linear scaling, experience rule, non-linear rule, theoretical calculation, or customized special mode. However, the invention is not limited thereto. In addition, how to obtain the image spectral distribution, the image spectral distribution variation, the accumulated value of image spectral distribution variation during a specific period, or the frequency of image spectral distribution variation is not limited in the invention.

Regarding the discrepancy of image frame, the control unit analyzes the discrepancy, the frequency of discrepancy variation, or the accumulated value of image frame discrepancy during a specific period of two consecutive image frames or between an N^{th} image frame and an M^{th} image frame.

Accordingly, the control unit can adaptively adjust the duty cycle or the frequency of the control signal according to the image frame discrepancy. The adjustment may be done through table lookup, linear scaling, experience rule, non-linear rule, theoretical calculation, or customized special mode. However, the invention is not limited thereto. In addition, how to obtain the image discrepancy is not limited in the invention.

Regarding the relevancy of image frames, the control unit analyzes the relevancy, the frequency of relevancy variation, or the accumulated value of image frame relevancy during a specific period of two consecutive image frames or between an N^{th} image frame and an M^{th} image frame.

Accordingly, the control unit can adaptively adjust the duty cycle or the frequency of the control signal according to the image frame relevancy. The adjustment may be done through table lookup, linear scaling, experience rule, non-linear rule, theoretical calculation, or customized special mode. However, the invention is not limited thereto. In addition, how to obtain the image relevancy is not limited in the invention.

Regarding the image color depth, when the color depth of the display driving apparatus changes, the control unit can adaptively adjust the duty cycle or the frequency of the control signal according to the color depth variation. For example, when the color mode of the display changes from a 262 k-color mode to a 16.7M-color mode or from the 16.7M-color mode to the 8-color mode, the control unit adaptively adjusts the duty cycle or the frequency of the control signal according to the color depth variation. In addition, how to switch to a color mode or which color mode to switch to is not limited in the invention.

Regarding image refresh rate, when the refresh rate of image frames changes, the control unit can adaptively adjust the duty cycle or the frequency of the control signal according to the refresh rate variation. For example, when the refresh rate of image frames changes from 60 Hz to 30 Hz or from 30 Hz to 60 Hz, the control unit adaptively adjusts the duty cycle or the frequency of the control signal according to the refresh rate variation.

Regarding the display mode of image frame, when the display mode of image frames changes, the control unit can adaptively adjust the duty cycle or the frequency of the control signal according to the display mode variation. For example, when the display mode of the image frame changes from a 2-dimensional (2D) mode to a 3-dimensional (3D) mode or from the 3D mode to the 2D mode, the control unit can adaptively adjust the duty cycle or the frequency of the control signal according to the display mode variation.

Regarding the sharpness of image frame, adjacent pixels of a solid-color image frame on the display panel are less frequently charged or discharged. Accordingly, when the control unit performs spectrum analysis and 2D fast Fourier transform (FFT) on the solid-color image frame, the control unit obtains a relatively smaller value. Contrarily, when the control unit performs spectrum analysis and 2D FFT on a more complicated image frame, the control unit obtains a relatively greater value. In addition, the image sharpness may also be calculated through other methods, and how the image sharpness is calculated is not limited in the invention.

Accordingly, the control unit can adaptively adjust the duty cycle or the frequency of the control signal according to the sharpness (i.e., the corresponding calculation value) of image frame. The adjustment may be done through table lookup, linear scaling, experience rule, non-linear rule, theoretical calculation, or customized special mode. However, the invention is not limited thereto.

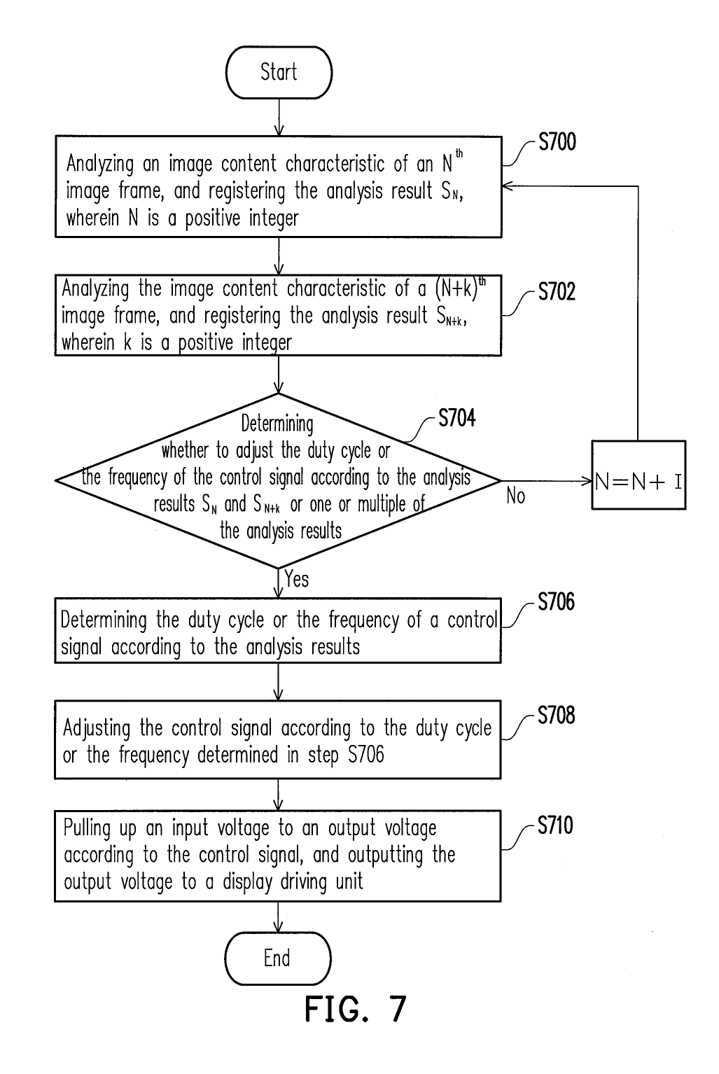

FIG. 7 is a flowchart of a power converting method according to another embodiment of the invention. Referring to FIG. 1 and FIG. 7, the difference between the power converting method in the present embodiment and the power converting method illustrated in FIG. 5 is that in the power converting method of the present embodiment, the analysis results of one or multiple image content characteristics are accumulated, and the duty cycle or the frequency of the control signal PWM is then determined according to the accumulated analysis results.

First, in step S700, the control unit 118 analyzes an image content characteristic of an N^{th} image frame and temporarily stores an analysis result S_{N}, wherein N is a positive integer.

In the present embodiment, the N^{th} image frame may be the currently displayed image frame. In other embodiments, the N^{th} image frame may also be an image frame of the image signal Sᵢₙ that has been displayed before or is to be displayed in the future.

Then, in step S702, the control unit 118 analyzes the image content characteristic of the (N+k)^{th} image frame and temporarily stores an analysis result S_{N+K}, wherein k is also an integer.

In the present embodiment, the image content characteristic of the N^{th} image frame and the (N+k)^{th} image frame analyzed by the control unit 118 may be the image brightness, the image spectral distribution, the image discrepancy, the image relevancy, the image color depth, the image refresh rate, or the display mode of the image frame.

Thereafter, in step S704, the control unit 118 continuously, discontinuously, or periodically determines whether to adjust the duty cycle or the frequency of the control signal according to the analysis results S_{N} and S_{k+N} or one or multiple of the analysis results.

For example, if the control unit determines to adjust the duty cycle or the frequency of the control signal, in step S706, the duty cycle or the frequency of the control signal is adjusted through table lookup, linear scaling, experience rule, non-linear rule, theoretical calculation, or customized special mode. However, the invention is not limited thereto.

Contrarily, if the control unit determines not to adjust the duty cycle or the frequency of the control signal, the duty cycle or the frequency of the control signal remains unchanged. Meanwhile, the control unit continues to analyze the image content characteristic of the (N+I)^{th} image frame, and so on. In other words, if the control unit determines not to adjust the duty cycle or the frequency of the control signal, the procedure returns to step S700 from step S704 to analyze the image content characteristic of the (N+I)^{th} image frame.

Next, in step S708, the control unit 118 adjusts the control signal PWM through a digital or analog technique according to the duty cycle or the frequency determined in step S706.

Finally, in step S710, the power converting unit 116 pulls up the input voltage Vᵢₙ to generate the output voltage Vₒᵤₜ according to the control signal PWM provided by the control unit 118 and outputs the output voltage Vₒᵤₜ to the display driving unit 114.

Thereby, in the power converting method of the present embodiment, the analysis results of one or multiple image content characteristics are accumulated, and the duty cycle or the frequency of the control signal PWM is then determined according to the accumulated analysis results.

In the power converting method of another embodiment, the duty cycle or the frequency of the control signal PWM corresponding to each analysis result is first determined, and the duty cycle or the frequency of the control signal PWM is then adaptively calculated.

In summary, in exemplary embodiments of the invention, a control unit of a power converting apparatus adjusts the duty cycle, frequency, or another electrical characteristics of a control signal according to the image content characteristics of one or multiple image frames in an image signal, so that a power converting unit can provide different power according to different display content of a display. Thereby, the power consumption is reduced and the efficiency is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power converting apparatus, comprising:
a power converting unit receiving an input voltage and generating an output voltage for a load according to a control signal; and
a control unit providing the control signal to the power converting unit, wherein the control unit adjusts an electrical characteristic of the control signal according to an image signal.

2. The power converting apparatus according to claim 1, wherein the control unit analyzes an image content characteristic of the image signal and adjusts a duty cycle or a frequency of the control signal according to an analysis result.

3. The power converting apparatus according to claim 2, wherein the control unit analyzes an image content characteristic of an N^{th} image frame of the image signal and adjusts the duty cycle or the frequency of the control signal according to the analysis result, wherein N is a positive integer.

4. The power converting apparatus according to claim 2, wherein the control unit analyzes image content characteristics of an N^{th} image frame to a (N+k)^{th} image frame of the image signal and adjusts the duty cycle or the frequency of the control signal according to the analysis result, wherein N and k are respectively a positive integer.

5. The power converting apparatus according to claim 2, wherein the control unit analyzes image content characteristics of an N^{th} image frame and a M^{th} image frame of the image signal and adjusts the duty cycle or the frequency of the control signal according to the analysis result, wherein N and M are respectively a positive integer, and M>N.

6. A power converting method, adapted to a power converting apparatus, the power converting method comprising:
adjusting an electrical characteristic of a control signal according to an image signal;
converting an input voltage into an output voltage according to the control signal; and
providing the output voltage to a load.

7. The power converting method according to claim 6, wherein the step of adjusting the electrical characteristic of the control signal comprises:
analyzing an image content characteristic of the image signal; and
adjusting a duty cycle or a frequency of the control signal according to an analysis result.

8. The power converting method according to claim 7, wherein the step of analyzing the image content characteristic of the image signal comprises:
analyzing an image content characteristic of an N^{th} image frame of the image signal; and
adjusting the duty cycle or the frequency of the control signal according to the analysis result, wherein N is a positive integer.

9. The power converting method according to claim 7, wherein the step of analyzing the image content characteristic of the image signal comprises:
analyzing image content characteristics of an N^{th} image frame to a (N+k)^{th} image frame of the image signal; and
adjusting the duty cycle or the frequency of the control signal according to the analysis result, wherein N and k are respectively a positive integer.

10. The power converting method according to claim 7, wherein the step of analyzing the image content characteristic of the image signal comprises:
analyzing image content characteristics of an N^{th} image frame and a M^{th} image frame of the image signal; and
adjusting the duty cycle or the frequency of the control signal according to the analysis result, wherein N and M are respectively a positive integer, and M>N.
